(19) United States
(12) Patent Application Publication
(10) Pub. No.: US 2026/0177696 A1
(43) Pub. Date: Jun. 25, 2026

(54) Use of Light as a Basis for Passive Login in an Audience Measurement System

(71) Applicant: The Nielsen Company (US), LLC, New York, NY (US)

(72) Inventors: Vladimir Kuznetsov, New York, NY (US); Alexander Topchy, New Port Richey, FL (US); Christen V. Nielsen, Tampa, FL (US); Meryem Berrada, Beacon, NY (US); Sadhana Gupta, Columbia, MD (US); Wendell D. Lynch, East Lansing, MI (US); Justin Dan Mathew, Fort Lauderdale, FL (US); David Gish, Riverdale, NJ (US)

(21) Appl. No.: 19/279,760

(22) Filed: Jul. 24, 2025

Related U.S. Application Data
(60) Provisional application No. 63/736,295, filed on Dec. 19, 2024.

(51) Int. Cl. G01S 17/04

(52) U.S. Cl. CPC G01S 17/04

(57) ABSTRACT

A system and method to use light as a basis to detect whether two meters are in a same location as each other and, if one of the meters is at a panelist and the other is at a media-presentation device, to detect whether the panelist and media-presentation device are in the same physical space as each other, and in turn to detect that the panelist is be exposed to media presented by the media presentation device. An example method includes receiving light information obtained by a first meter, receiving light information obtained by a second meter, and correlating the first and second light information as a basis to detect presence of the first meter in the same location as the second meter.

### REFERENCE TO RELATED APPLICATION

This application claims priority to U.S. Provisional Ser. No. 63/736,295, filed Dec. 19, 2024, the entirety of which is hereby incorporated by reference.

### BACKGROUND

A media-measurement company may measure audience-measurement data (e.g., the extent to which people of various demographics engage with and/or are otherwise exposed to media content). To do so, the media-measurement company may implement media-monitoring devices at representative households or other sites. These media-monitoring devices may monitor the media content (e.g., audio content, video content, etc.) that one or more media-presentation devices (“MPDs”) (e.g., televisions, computers, tablets, phones, gaming devices, smart speakers, radios, streaming-media players, set top boxes, audio-visual receivers, etc.) present. People who opt into and thus consent to such monitoring may be considered “panelists,” and the places where the monitoring occurs (e.g., homes, offices, other premises, etc.) may be considered “panelist sites.”

To correlate MPD-presented media with a particular panelist, it may be necessary to determine whether the particular panelist was present at the MPD when the MPD was presenting media content. To facilitate determining whether a panelist was present at an MPD when the MPD was presenting media content, the panelist may perform an affirmative action to “log in.” For instance, the panelist may select the panelist's name from a menu presented by the MPD, or the panelist may press a panelist-specific button on the MPD, among other possibilities.

This panelist login may also facilitate a determination that the particular panelist was exposed to the media presented by the MPD, including an extent of the media exposure (e.g., total number of minutes that the panelist was present where the MPD was presenting the media content), which may then be correlated with demographics of the panelist, to establish audience-measurement data. Establishing such audience-measurement data may in turn facilitate placement of personalized ads (e.g., ads of interest to the panelist) and/or other useful operations.

### SUMMARY

Although correlating the panelist with the MPD may involve the panelist performing an affirmative login action, having the panelist perform such an affirmative login action as the only basis for correlating the panelist with the MPD may pose a technical challenge. For example, in some cases, the panelist may fail to perform the affirmative login action when the panelist is present at the MPD when the MPD is presenting media content. When that happens, it may be difficult to determine media exposure data for the panelist, due to incomplete information regarding when the panelist was present at the MPD.

A technical solution to this challenge may be to implement a passive login process that does not depend (or does not depend solely) on the panelist performing an affirmative login action. One form of passive login may include obtaining and correlating audio obtained at the MPD with audio obtained at the panelist. A basis for such a login process may be that the MPD may present media content, in part, by causing the emission of audio through one or more loudspeakers of or associated with the MPD. In such cases, there may be changes over time in the emitted audio (e.g., increases or decreases in volume) associated with the media content presented by the MPD. Consequently, if and when the panelist is located at the MPD, the changes over time in the emitted audio obtained at the MPD should largely be the same as the changes over time in the emitted audio obtained at the panelist. Detecting the presence of the panelist based on matching of these changes in audio over time is a form of audio-based passive login because the detection is based on the audio that the one or more loudspeakers emit.

In an example of this audio-based passive login process, a meter at the MPD (an “MPD meter”) and a meter at the panelist (a “panelist meter”) (e.g., in the panelist's hand, in the panelist's pocket, on the panelist's wrist, etc.) may each include one or more audio sensors (e.g., microphones) that receive the audio emitted by the loudspeakers. By receiving the audio emitted by the loudspeakers, the MPD meter and the panelist meter may each obtain timestamped audio signatures (e.g., watermark codes, digital fingerprints, etc.) associated with the audio. Both meters may send these timestamped audio signatures to a computing system (or the computing system may be in one of the meters and the other meter may send its timestamps to that computing system). Based on the timestamps, the computing system may then compare those audio signatures with each other.

This comparison may act as a basis to detect presence of the panelist where the MPD was presenting the media content. In particular, if the audio signatures of common timestamps match each other over time, then, based at least in part on the match between the audio signatures, the computing system may determine that the panelist was present where the MPD was presenting the media content represented by those audio signatures and may establish that the panelist was exposed to that media content. Whereas, if the audio signatures of common timestamps do not match each other over time, then, based at least in part on the lack of a match between audio signatures, the computing system may determine that the panelist was not present where the MPD was presenting the media content represented by those audio signatures (e.g., the computing system may not determine that the panelist was present where the MPD was presenting the media content), and may thus not establish that the panelist was exposed to the media content.

A potential issue with this audio-based passive login process is that such a process is based on the one or more loudspeakers emitting audio in a manner that at least the two meters are able to receive. As a result, the audio-based passive login process might perform poorly (or not perform at all) in a situation where the MPD is presenting media content but where the one or more loudspeakers do not emit audio in a manner that the two meters can receive. For example, the audio-based passive login process would not work in a situation where the panelist uses a personal listening device, such as headphones, earbuds, an augmented reality headset, or the like, to listen to the audio of the MPD, and where the MPD or an associated audio output device provides its audio directly to the panelist's personal listening device rather than outputting the audio through one or more loudspeakers.

The present disclosure provides a technical advance that may help to overcome this technical issue and may also be useful in other scenarios as well. In accordance with the disclosure, a computing system uses ambient light as a basis for passive login of a panelist. To do so, the computing system correlates ambient light intensity at the panelist with ambient light intensity at the MPD, as a basis to establish passive login of the panelist.

To facilitate this light-based passive login, the MPD meter and the panelist meter may each include a light sensor (e.g., one or more photodiodes, light-dependent resistors, etc.) configured to sense ambient light intensity. Specifically, the MPD meter may include a light sensor configured to obtain ambient light intensity in an area around the MPD, and the panelist meter may include a light sensor configured to obtain ambient light intensity in an area around the panelist.

Passive login of the panelist with respect to the MPD may then involve correlating ambient light obtained by the MPD meter with ambient light obtained by the panelist meter. For instance, the passive login may involve correlating a change in ambient light intensity over time as obtained by the MPD meter with a change in ambient light intensity over time as obtained by the panelist meter at the same time.

This light-based passive login process may be based at least in part on changes (e.g., increases or decreases) in the ambient light intensity associated with changes in brightness of the media content presented by the MPD. For instance, the media content presented by the MPD may include brighter or darker scenes from time to time. Changes between such scenes may result in changes in the light intensity associated with the media content presented by the MPD over time. Such changes in light intensity may thus result in corresponding changes in ambient light in the space where the MPD is located. Consequently, if and when the panelist is located in that space as well, the MPD meter and the panelist meter should obtain largely the same change in ambient light as each other.

In an example of this light-based passive login process, the computing system may receive timestamped ambient light information obtained respectively by the MPD meter and the panelist meter. Based on the timestamps, the computing system may then compare the ambient light information over time as obtained by these meters to each other, as a basis to detect the panelist presence at the MPD when the MPD was presenting the media content.

In particular, if the change in ambient light intensity over time as obtained by the MPD meter matches the change in ambient light intensity over time as obtained by the panelist meter at the same time, then, based at least in part on this match, the computing system may determine that the panelist was present where the MPD was presenting the media content and may establish that the panelist was exposed to that media content. Whereas, if the change in ambient light intensity over time as obtained by the MPD meter does not match the change in ambient light intensity over time as obtained by the panelist meter at the same time, then, based at least in part on the absence of a match, the computing system may determine that the panelist was not where the MPD was presenting the media content (e.g., the computing system may not determine that the panelist was present where the MPD was presenting the media content), and may thus not establish that the panelist was exposed to the media content.

A computing system may use one or more active and/or passive login methods (e.g., some or all of the methods described above) to correlate a particular panelist with particular media content. This correlation can then be used by the computing system as a basis to establish audience-measurement data.

Such audience-measurement data may be based on the computing system correlating (i) the particular panelist that was present where the MPD was presenting media content with (ii) the particular media content that the MPD was presenting at the time. Through this correlation, the computing system may conclude that the particular panelist was exposed to the presentation of that particular media content. Such a conclusion may involve two determinations. The first determination is of whether the panelist was present where the MPD was presenting the media content, and the second determination is of the identity of the media content presented by MPD at the time.

The computing system may use at least the light-based passive login process described herein as a basis to make the first determination. Further, the computing system may make the second determination in various ways. For example, the computing system may receive a signal that indicates the identity of the media presented by the MPD. As another example, the computing system may use automatic content recognition to identify the media presented by the MPD. As a specific example of such automatic content recognition, the computing system may receive from one or both of the meters (i.e., from the MPD meter and/or the panelist meter) audio signature data, such as digital fingerprints or watermarks, representing the media being presented and may then match that audio signature data against reference signature data representing known content items (e.g., known programs).

These and other aspects, advantages, and alternatives, will become apparent to those of ordinary skill in the art by reading the following detailed description, with reference where appropriate to the accompanying drawings. Further, it should be understood that the disclosure provided in this summary and elsewhere in this document is provided by way of example only and that numerous variations and other examples may be possible as well.

### BRIEF DESCRIPTION OF THE DRAWINGS

FIG. 1 is a simplified block diagram illustrating an example system.

FIG. 2A is a flow chart illustrating an example method.

FIG. 2B is another flow chart illustrating an example method.

FIG. 3 is a simplified block diagram of an example computing system.

FIG. 4 is a simplified block diagram of an example meter.

### DETAILED DESCRIPTION

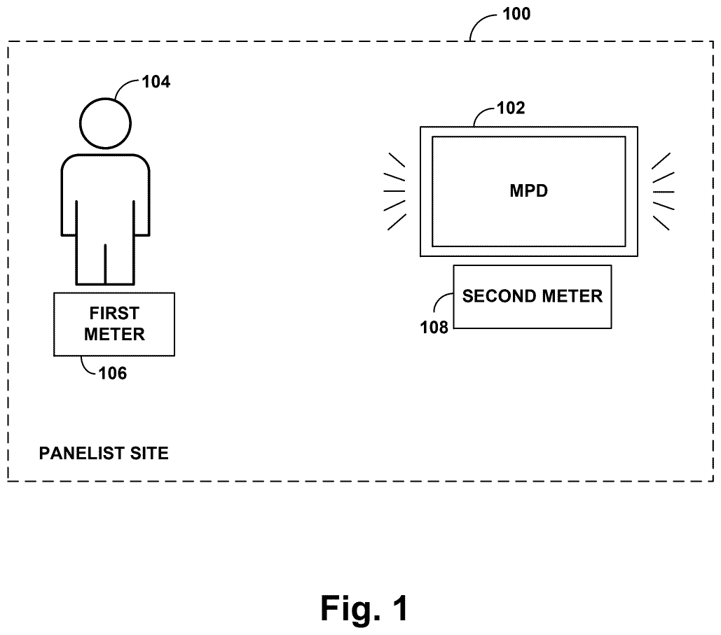

Referring to the drawings, FIG. 1 is a simplified block diagram of aspects of an example system that could implement some or all of the embodiments described herein. It will be understood, however, that this and other arrangements and processes described herein could take various other forms. For instance, elements and operations could be re-ordered, distributed, replicated, combined, omitted, added, or otherwise modified. In addition, elements described as functional entities could be implemented as discrete or distributed components or in conjunction with other components/modules, and in any suitable combination and location. Further, various operations described as being carried out by one or more entities could be implemented by and/or on behalf of those entities, through hardware, firmware, and/or software, such as by one or more processing units executing program instructions stored in memory, among other possibilities.

As shown in FIG. 1, the example system includes, at a panelist site 100 (e.g., a panelist's home or office, a particular room within the panelist's home or office, among other possibilities), an MPD 102 (e.g., a television, a computer, a tablet, a phone, a gaming device, a smart speaker, a radio, a streaming-media player, a set top box, an audio-visual receiver, etc.) and a panelist 104.

The MPD 102 may be configured to present media content by causing emission of audio (e.g., audio content) and/or display of images (e.g., video content). This media content may include program content (e.g., television programs and/or movies) and/or ad content (e.g., commercial breaks). In some implementations, the MPD 102 may present the audio content while presenting the video content. The MPD 102 may present audio content, in part, by causing the emission of audio through one or more loudspeakers of or associated with the MPD 102. The properties of this emitted audio (e.g., volume, frequency distribution, etc.) may change over time.

The MPD 102 may present video content by causing the display of images by one or more display screens of or associated with the MPD 102. The display of images may involve the emission of light by the one or more display screens of or associated with the MPD 102. Such emission of light can include the operation of one or more light emitters and/or other elements to generate or otherwise provide the emitted light. The properties of this emitted light (e.g., intensity, frequency distribution, etc.) may change over time based on the images that the MPD 102 causes to display.

The panelist 104 may be exposed to the media content that the MPD 102 was presenting by the panelist 104 being present where the MPD 102 was presenting the media content. The panelist 104 may be present where the MPD 102 was presenting media content by the panelist 104 being present at the MPD 102 at the time of the media presentation, such as by panelist 104 and MPD 102 being in the same room or other physical space as each other at the time of the media presentation. Further, in some implementations, the panelist 104 may be present where the MPD 102 was presenting the media content specifically by the panelist 104 being situated in viewing range of a front of a display screen of or associated with the MPD 102, among other possibilities.

To facilitate audience measurement, as noted above, various methods could be used to establish that the panelist 104 is present with and thus associated with the MPD 102 at the time the MPD 102 is presenting media content. These methods could include affirmative login, where the panelist 104 actively performs a login action (e.g., selecting the panelist's name from a login menu presented by the MPD 102, or pressing a panelist-specific button on an MPD meter). Further, as presently contemplated, these methods could include passive login, where a system detects the panelist's presence at the MPD 102 without a need for the panelist to actively take a login action. In practice, these methods could also be combined. For instance, a system may implement both active login and passive login, possibly using one method as a basis to confirm the login established by the other method.

To implement passive login, additional components or devices could be provided at the MPD 102 and/or the panelist 104. For example, as shown in FIG. 1, a first meter 106 could be provided at the panelist 104, and a second meter 108 could be provided at the MPD 102. These meters could be provided “at” the panelist 104 and MPD 102 respectively by being close enough to the panelist 104 and MPD 102 to facilitate carrying out the present process. For instance, the first meter 106 could be at the panelist 104 by being carried, worn, or otherwise accompanying the panelist 104 and being exposed to the environment of the panelist 104 to facilitate detecting light and/or audio at the panelist 104 for present purposes. And the second meter 108 could be provided at the MPD 102 by being situated on, next to, in, or otherwise near enough to the MPD 102 and being exposed to the environment of the MPD 102 to facilitate detecting light and/or audio at the MPD 102 for present purposes.

These meters could include respective processors, non-transitory data storage, and program instructions that are stored in their non-transitory data storage and are executable by their processors to carry out various meter operations as described herein, among other arrangements.

For light-based passive login, the first meter 106 may operate to obtain first light information at the panelist 104, and the second meter 108 may operate to obtain second light information at the MPD 102. To facilitate this, the first meter 106 may contain or be interconnected with one or more light sensors configured to sense ambient light intensity in an area around the first meter 106, and the second meter 108 may contain or be interconnected with one or more light sensors configured to sense ambient light intensity in an area around the second meter 108. These light sensors could comprise photodiodes, phototransistors, active pixel sensors, image sensors, and/or light-dependent resistors, among other possibilities.

When the first meter 106 obtains the first light information, the first meter 106 may timestamp the first light information, e.g., by recording, in association with the first light information, timestamps indicting time of receipt of the first light information. Similarly, when the second meter 108 obtains the second light information, the second meter 108 may timestamp the second light information, e.g., by recording, in association with the second light information, timestamps indicting time of receipt of the second light information. Such timestamps may represent an absolute or relative time of onset of the respective light information, a duration of the respective light information, an absolute or relative time of the end of the respective light information, a set of one or more specified points in time or period of time during which the respective light information was detected, an absolute or relative time of a specified sample, peak, change, or other feature of the light information, and/or some other representation of the timing of the respective light information, among other possibilities.

In some cases, the first meter 106 may obtain the first light information at the same time that the second meter 108 obtains the second light information, and therefore the timestamps associated with the first light information may match the timestamps associated with the second light information. The meters obtaining the light information “at the same time” as each other may mean that they obtain the light information at exactly the same time as each other or at nearly the same time as each other, such as within several milliseconds or another reasonably small time range that would facilitate the present process. Likewise, the timestamps matching each other may mean that the timestamps are exactly the same as each other or are similarly within a reasonably small time range of each other.

For audio-based passive login, on the other hand, the first meter 106 may operate to obtain first audio information at the panelist 104, and the second meter 108 may operate to obtain second audio information at the MPD 102. To facilitate this, the first meter 106 may contain or be interconnected with one or more audio sensors (e.g., microphones) configured to sense ambient audio in an area around the first meter 106, and the second meter 108 may contain or be interconnected with one or more audio sensors configured to sense ambient audio in an area around the second meter 108.

When the first meter 106 obtains the first audio information, the first meter 106 may timestamp the first audio information, e.g., by recording, in association with the first audio information, timestamps indicting time of receipt of the first audio information. Similarly, when the second meter 108 obtains the second audio information, the second meter 108 may timestamp the second audio information, e.g., by recording, in association with the second audio information, timestamps indicting time of receipt of the second audio information. These timestamps may represent an absolute or relative time of onset of the respective audio information, a duration of the respective audio information, an absolute or relative time of the end of the respective audio information, a set of one or more specified points in time or period of time during which the respective audio information was detected, an absolute or relative time of a specified sample, peak, change, or other feature of the audio information, and/or some other representation of the timing of the respective audio information, among other possibilities.

In some cases, the first meter 106 may obtain the first audio information at the same time that the second meter 108 obtains the second audio information, and therefore the timestamps associated with the first audio information may match the timestamps associated with the second audio information. The meters obtaining the audio information “at the same time” as each other may mean that they obtain the audio information at exactly the same time as each other or at nearly the same time as each other, such as within several milliseconds or another reasonably small time range that would facilitate the present process. Likewise, as noted above, timestamps matching each other may mean that the timestamps are exactly the same as each other or are similarly within a reasonably small time range of each other.

Further, in some cases, the first meter 106 may obtain the first audio information at largely the same time that the first meter 106 obtains the first light information, in which case the timestamps associated with the first audio information may also match the timestamps associated with the first light information. Likewise, the second meter 108 may obtain the second audio information at largely the same time that the second meter 108 obtains the second light information, in which case the timestamps associated with the second audio information may also match the timestamps associated with the second light information.

In practice, the light and/or audio information obtained by the first meter 106 and second 108 meter could be used in various ways as a basis to determine whether the panelist 104 was present at the second meter 108. Where the second meter is at the MPD 102, this information may therefore be used in various ways as a basis to determine whether the panelist 104 was present at the MPD 102.

For example, if the first meter 106 is in the same location, such as the same room or other same physical space, as the second meter 108, then a reasonable expectation would be that the first light information over time would match the second light information over time. For instance, the first light information and the second light information may have peaks and/or valleys at similar times, the first light information and the second light information may have similar frequency spectra at similar time, and/or the first light information and the second light information may have similar pixel color histograms at similar times.

A computing system may thus be configured to correlate the first light information with the second light information as a basis to determine whether the first meter 106 was in the same location as the second meter 108 and thus, if the first meter 106 is at the panelist 104 and the second meter 108 is at the MPD 102, to determine whether the panelist 104 was at the MPD 102.

This computing system could be provided at various locations and/or distributed. For instance, the computing system may be part of the first meter 106, part of the second meter 108, and/or disposed at server within the panelist site 100 or other location (e.g., in a cloud-based, back-office system operated by a media-measurement company).

The computing system could determine in various ways whether the first light information over time matches the second light information over time and thus whether the first meter 106 was in the same location as the second meter 108.

By way of example, respectively for the timestamped first light information and the timestamped second light information, the computing system may analyze the light information to identify changes in the light information over time, such as respective increases, decreases, or other variations in intensity, color, etc., and to may determine associated timestamps of those identified changes. The computing system may then compare a set of such identified timestamped changes in the first light information with a set of such identified timestamped changes in the second light information to determine how well they correspond. One way to conduct this comparison is to determine a percentage of timestamps at which identified changes in the first light information match identified changes in the second light information. If at least a predefined threshold percentage of those timestamps (with the threshold being on the order of 50% to 100%) have matching identified changes in light information, then the computing system may conclude that the first meter 106 was in the same physical space as the second meter 108 at the time. Whereas, absent such a threshold match, the computing system may conclude that the first meter 106 was not in the same physical space as the second meter 108 at the time.

The computing system could conduct this analysis on a discrete time window or sliding time window basis. For instance, the computing system could conduct this analysis over windows of 30 seconds, 1 minute, 10 minutes, or some other duration. As a result, the computing system could determine on a per time window basis whether the first meter 106 was in the same physical space as the second meter 108, and thus, if the first meter 106 was at the panelist 104 and the second meter 108 was at the MPD 102, whether the panelist 104 was present at the MPD 102 at the time.

The computing system could also apply various statistical comparison techniques as a basis to determine whether the first light information matches the second light information for a given period of time. For instance, given timestamped first and second light information, the computing system may determine a similarity measure, such as Pearson correlation, a Spearman correlation, a mean squared error, and/or a cosine similarity, between the first light information and the second light information. The computing system may then determine whether this similarity measure is greater than a threshold. For example, if the similarity measure is the Spearman correlation, the threshold may be any number between 0 and 1. If the similarity measure is greater than the threshold, then, based at least in part on the similarity measure being greater than the threshold, the computing system may determine that the first meter 106 was in the same location as the second meter 108 during the period of time. Whereas, if the similarity measure is not greater than the threshold, then, based at least in part on the similarity measure not being greater than the threshold, the computing system may determine that the first meter 106 was not in the same location as the second meter 108 during the period of time.

As noted above, the MPD 102 may present video content, in part, by causing emission of light by the one or more display screens of or associated with the MPD 102. Therefore, the light information detected by the second meter 108 at the MPD 102 may include at least a portion of the light emitted by the one or more display screens of or associated with the MPD 102. If also follows that, if and when the panelist 104 is in the same physical space as the MPD 102 and the first meter 106 is at the panelist 104, the light information detected by the first meter 106 should also include at least a portion of the light emitted by the one or more display screens of or associated with the MPD 102. This light emitted by the one or more display screens may thus form a basis for matching of the light information for given period of time, and for a consequent determination that the panelist 104 was at the MPD 102 at that time.

The computing system may use the methods described above to determine whether the first meter 106 was in the same location as the second meter 108 during the window of time as a basis to determine whether the panelist 104 was present at the MPD 102 at that time. The computing system may conduct this analysis in real-time at the time of receipt of the timestamped light information, to facilitate a determination of whether the panelist 104 was present at that time at the MPD 102. Alternatively, the computing system may conduct this analysis later, such as each evening, to determine past times when the panelist 104 was present at the MPD 102.

For example, if the first meter 106 was at the panelist 104 and the second meter 108 was at the MPD 102, and if the computing system determines that the first meter 106 and second meter 108 were in the same location (i.e., same physical space) as each other at a given time, then, based at least in part on the determination that the first meter 106 and second meter 108 were in the same location as each other at that time, the computing system may determine that the panelist 104 was present at the MPD 102 at that time. Whereas, if the if the first meter 106 was at the panelist 104 and the second meter 108 was at the MPD 102, and if the computing system determines that the first meter 106 and second meter 108 were not in the same location (i.e., same physical space) as each other at a given time, then, based at least in part on the determination that the first meter 106 and second meter 108 were not in the same location as each other at that time, the computing system may determine that the panelist 104 was not present at the MPD 102 at that time.

An example implementation of this process usefully applies with respect to a scenario where the MPD 102 was presenting media content on one or more display screens. As to that scenario, a determination, through light-based passive login, that the panelist 104 was present at the MPD 102 could be used as a basis to establish audience measurement data. Namely, the determination that the panelist 104 was present at the MPD 102 at a given time could be correlated with a determination of what media content the MPD 102 was presenting at that time, as a basis to conclude that the panelist 104 was exposed to that media-content presentation at that time.

The present process need not be limited, however, to scenarios where the MPD 102 was presenting media content, and the matching of light information need not necessarily relate to light emitted by one or more display screens of the MPD 102. For instance, the process could apply to determine presence of the panelist 104 in other scenarios even where the MPD 102 was not presenting media content at the time and possibly even in scenarios where there is no MPD 102.

There may be other reasons, for instance, to determine based on correlation of light information whether a panelist or other person having the first meter 106 was in the same physical space as the second meter 108. For instance, other applications of this principle include, without limitation, (i) determining based on light correlation that a person with a first meter was in the same physical space as a museum display having a second meter, and (ii) determining based on light correlation that a person with a first meter was in a room having a second meter, for security monitoring, attendance tracking, or the like.

In addition to or instead of applying light-based passive login, the computing system may also apply audio-based passive login if the meters are configured to receive respective audio information. In particular, to determine whether the panelist 104 was in the same location as the MPD 102, the computing system could use the first audio information obtained by the first meter 106 and the second audio information obtained by the second meter 108, performing comparisons like those noted above for the light information.

In a scenario where the MPD 102 presents audio content by emission of audio through one or more loudspeakers of or associated with the MPD 102, both the first and second audio information may include at least a portion of that emitted audio. Consequently, if the first audio information including this emitted audio matches the second audio information including this emitted audio, the computing system may conclude that the first meter 106 was in the same location as the second meter at the time and, if the first meter 106 is at the panelist 104 and the second meter 108 was at the MPD 102, that the panelist 104 was present at the MPD 102 at the time.

Further, as with the light information, this comparison and process need not be limited to a scenario where the MPD 102 is emitting audio but may more generally apply with respect to ambient audio as a basis to determine whether the first meter 106 was in the same physical space as the second meter 108, and thus perhaps that a person having the first meter 106 was in the same physical space where the second meter 108 was located at the time.

In implementations where the MPD 102 was presenting media content, the computing system may use the methods described herein as a basis to establish audience-measurement data. In particular, as noted above, the audience-measurement data may be based on the computing system correlating (i) the presence of the panelist 104 where the MPD 102 was presenting media content with (ii) the identity of the media content that the MPD was presenting at that time. Through this correlation, the computing system may conclude that the panelist 104 was exposed to the presentation of that particular media content at that time.

In particular, the computing system may apply light-based passive login and/or audio-based passive-login as a basis to determine that the panelist 104 was present at where the MPD 102 was presenting media content. Further, the computing system could apply any of various methods to determine the identity of the media content that the MPD 102 was presenting at the time. For example, the computing system may receive, from the MPD 102, from a system providing media content to the MPD 102 (e.g., a cable box), and/or from some other system, a signal that indicates the identity of the media that the MPD 102 was presenting. As another example, the computing system may use automatic content recognition to identify the media that the MPD 102 was presenting.

In some implementations, automatic content recognition may be based on audio signature data encoded in the audio content that the MPD 102 was presenting. By obtaining audio information based on the audio content that the one or more loudspeakers of or associated with the MPD 102 emitted, the first meter 106 and/or the second meter 108 may obtain audio signature data encoded in the audio content. The computing system may then receive this audio signature data from the first meter 106 and/or the second meter 108. This audio signature data may include digital fingerprints and/or watermarks.

Regarding digital fingerprints, the first meter 106 and/or the second meter 108 may generate digital query fingerprints based upon component characteristics of the audio information, such as audio frequency characteristics of the audio information. Further, each of the digital query fingerprints may be associated with a timestamp indicating the time at which the first meter 106 and/or the second meter 108 obtained the audio information from which the digital query fingerprint is based.

The computing system may periodically receive bundles of these digital query fingerprints from the first meter 106 and/or the second meter 108. The computing system may then compare the received digital query fingerprints with reference digital fingerprints representing known media content (e.g., known programs, ads, channels, etc.). If the computing system determines that the digital query fingerprint matches a particular reference digital fingerprint with sufficient certainty, then, based at least in part on that determination, the computing system may reasonably conclude that the MPD 102 was presenting the particular media content to which that particular reference digital fingerprint corresponds. In addition, if the digital query fingerprint is associated with a timestamp, then the computing system may use this timestamp to conclude that the MPD 102 was presenting the particular media content at a time indicated by the timestamp.

As to watermarking, on the other hand, the audio content may periodically include an audio watermark that identifies the audio content. By way of example, if the identity of the audio content is a sequence of digits, each digit could be sequentially encoded into the audio by adding a unique tone combination having a predefined correlation with the digit. Further, synchronizing symbols may be encoded as respective tone combinations as well, to demarcate the presence of the watermark.

As the MPD 102 presents audio content that includes watermarks, the first meter 106 and/or the second meter 108 may monitor the information for presence of these watermarks. Upon finding a watermark, the first meter 106 and/or the second meter 108 may decode the watermark by evaluating the sequential tone combinations, and may thereby extract the media-identifying information. By decoding the watermark, the first meter 106 and/or the second meter 108 may associate the media-identifying information with timestamps indicating when the MPD 102 was presenting the watermarked media. Further, the computing system may receive this information from the first meter 106 and/or the second meter 108 and may verify the information by a comparison to reference information.

Whether through use of fingerprinting, watermarking, and/or one or more other processes, the computing system may thereby identify the particular media content that the MPD 102 was presenting at a given time. Moreover, if the computing system determines through a passive-login process that the panelist was present at the MPD 102 at that time, then the computing system may correlate those two data points to establish that the panelist 104 was present at the MPD 102 at the time the MPD 102 was presenting the identified media content, and thus that the panelist 104 was exposed to that media-content presentation.

The computing system may further correlate this media exposure information with predetermined demographics information of the panelist 104, to establish that a panelist having such demographics information was exposed to the identified media content. Further, the computing system may aggregate this exposure information across multiple panelists within panelist site 100 and/or across panelist sites as a basis to establish audience-measurement data. And any of this audience-measurement data may be used to as a basis to generate more comprehensive ratings statistics, which may help inform and control later program or ad placement and/or other actions.

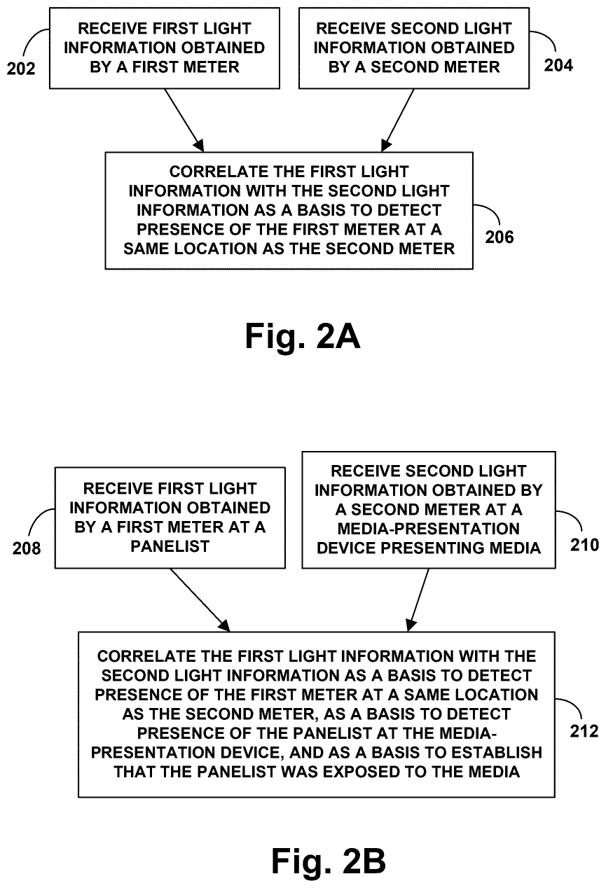

FIG. 2A is a flow chart illustrating an example method. As shown in FIG. 2A, at block 202, the example method includes receiving first light information obtained by a first meter. Further, at block 204, the example method includes receiving second light information obtained by a second meter. In addition, at block 206, the example method includes correlating the first light information with the second light information as a basis to detect presence of the first meter at a same location as the second meter.

In line with the discussion above, the first light information may include one or more first timestamps indicating when the first meter obtained the first light information. Further, the second light information may include one or more second timestamps indicating when the second meter obtained the second light information. When both the first light information and the second light information include timestamps, the act of correlating the first light information with the second light information may be based on the one or more first timestamps and the one or more second timestamps.

Further, the first meter may be a meter at a media-presentation device and the second meter may be a meter at a panelist. In such cases, the act of correlating the first light information with the second light information may serve as a basis to detect a presence of the panelist at the media-presentation device.

Still further, the act of correlating the first light information with the second light information may also serve as a basis to detect that, when the media-presentation device was presenting media content, the panelist was present at the media-presentation device.

Moreover, the method may involve receiving, by the computing system, audio information obtained by the first meter. The first meter may obtain this audio information while the first meter obtains the first light information. In cases when the first meter obtains the audio information, the method may further include identifying, based on the audio information, the media content presented by the media-presentation device, and establishing audience-measurement data. Further, in such cases, the act of establishing may be based on correlating the identified media content with the panelist.

In addition, the audio information may include audio signature data, such as audio fingerprint data and/or audio watermark data.

Further, the first light information may include one or more first timestamps indicating when the first meter obtained the first light information. In such cases, the audio information may include one or more audio timestamps indicating when the first meter obtained the audio information. In addition, in such cases, the act of correlating the identified media content with the panelist may be based on the one or more first timestamps and one or more audio timestamps.

Further, the act of correlating, by the computing system, the first light information with the second light information may include determining a similarity value between the first light information and the second light information. In such cases, the act of detecting presence of the first meter at the same location as the second meter may be based on determining that the similarity value is greater than a threshold.

In addition, the similarity value between the first light information and the second light information may include a Spearman correlation between the first light information and the second light information.

Moreover, the first light information may be based on an ambient light intensity at the first meter and the second light information may be based on an ambient light intensity at the second meter.

FIG. 2B is a more specific flow chart illustrating an example method that involves using light-based passive login as a basis to detect panelist exposure to media. As shown in FIG. 2B, at block 208, the method includes receiving, e.g., by a computing system, first light information obtained by a first meter at a panelist. Further, at block 210, the method includes receiving, e.g., by the computing system, second light information obtained by a second meter at an MPD presenting media (i.e., at an MPD that was presenting media at the time). Still further, at block 212, the method includes correlating, e.g., by the computing system, the first light information with the second light information as a basis to detect presence of the first meter at a same location as the second meter, as a basis in turn to detect presence of the panelist at the media-presentation device, and as a basis in turn to establish that the panelist was exposed to the media.

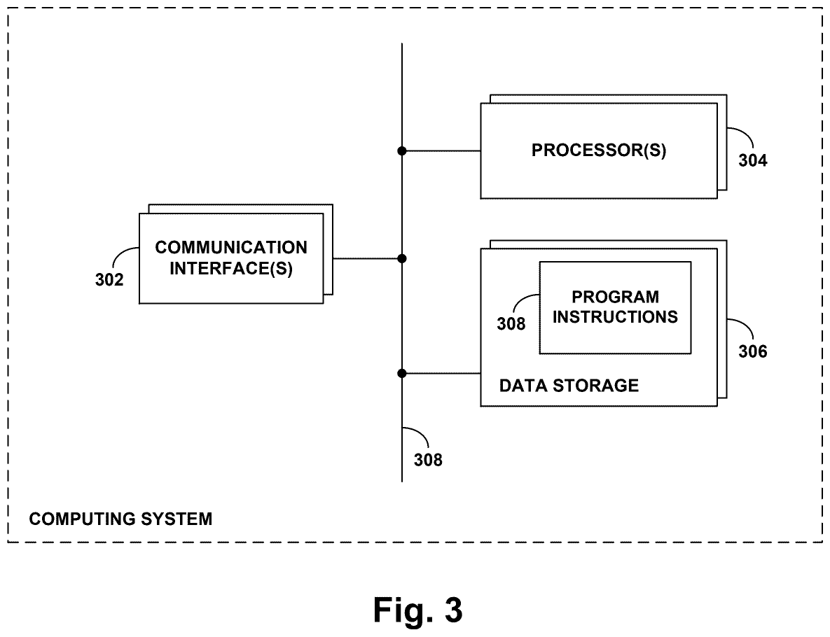

FIG. 3 is a simplified block diagram of an example computing system that may configured to carry out various operations such as those discussed herein. As shown in FIG. 3, the example computing system includes at least one communication interface 302, at least one processor 304, and at least one non-transitory data storage 306, which may be interconnected by a system bus or other mechanism 308 or may be integrated together, among other possibilities.

The at least one communication interface 302 may include one or more modules to facilitate wired and/or wireless communication with one or more other entities. Examples of such modules could include, without limitation, wired Ethernet interfaces and/or WiFi interfaces.

The at least one processor 304 may include one or more general purpose processors (e.g., microprocessors) and/or one or more specialized processors (e.g., digital signal processors (DSPs), graphics processing units (GPUs), neural processing units (NPUs), etc.)

And the non-transitory data storage 306 may include one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 300 or may be provided separately.

As further shown, the non-transitory data storage 306 may store (e.g., hold or embody) program instructions 310. These program instructions 310 may be executable by the at least one processor 304 to cause the computing system to carry out various operations as described herein.

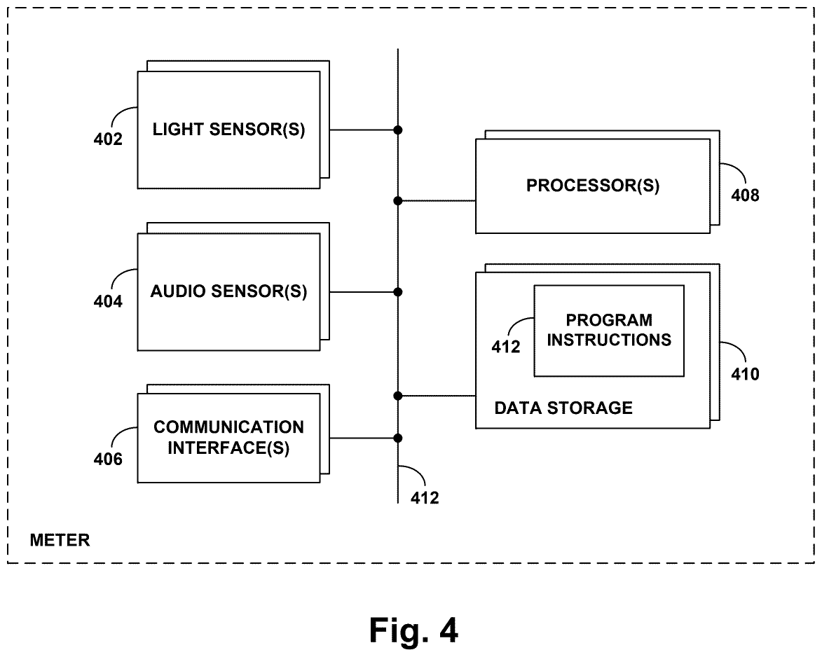

FIG. 4 is next a simplified block diagram of an example meter, which may be configured to operate as the first meter 106 and/or the second meter 108. In line with the discussion above, this example meter may be at the MPD 102 or at the panelist 104.

As shown in FIG. 4, the example meter includes at least one light sensor 402, at least one audio sensor 404, at least one communication interface 406, at least one processor 408, and at least one non-transitory data storage 410, which may be interconnected by a system bus or other mechanism 412 or may be integrated together, among other possibilities.

The at least one light sensor 402 may include one or more photodiodes and/or one or more light-dependent resistors configured to sense ambient light information around the example meter 400. Further, the at least one light sensor 402 may also include processing circuitry or other logic associated with the one or more photodiodes and/or one or more light-dependent resistors. Through sensing the ambient light information in an area around the example meter 400, the example meter 400 may obtain first light information and/or second light information, to facilitate light-based passive login.

The at least one audio sensor 404 may include one or more microphones and associated processing circuitry or other logic configured to obtain audio information around the example meter 400. The at least one audio sensor 404 may thus operate to facilitate identification of the media content that the MPD 102 was presenting, and may also operate to facilitate audio-based passive login. The at least one audio sensor 404 may do so by obtaining audio signature data.

The at least one communication interface 406 may include one or more wired and/or wireless network interfaces, such as wired Ethernet interfaces and/or WiFi interfaces, to facilitate communication with other entities. The example meter may use the at least one communication interface 406 to send first light information, second light information, and/or audio information to the example computing system. Alternatively, if the computing system is provided at one of the meters, light information from that meter may be provided internally to the computing system of that meter.

The at least one processor 408 may include one or more general purpose processors (e.g., microprocessors) and/or one or more specialized processors (e.g., DSPs, GPUs, NPUs, etc.)

And the non-transitory data storage 410 may include one or more volatile and/or non-volatile storage components (e.g., flash, optical, magnetic, ROM, RAM (e.g., DRAM, SRAM, or DDRAM), EPROM, and/or EEPROM, etc.), which may be integrated in whole or in part with the processor 300 or may be provided separately.

Exemplary embodiments have been described above. Those skilled in the art will understand, however, that changes and modifications may be made to these embodiments without departing from the true scope and spirit of the invention.

What is claimed is:

1. A method comprising:
receiving, by a computing system, first light information obtained by a first meter;
receiving, by the computing system, second light information obtained by a second meter; and
correlating, by the computing system, the first light information with the second light information as a basis to detect presence of the first meter at a same location as the second meter.

2. The method of claim 1,
wherein the first light information includes one or more first timestamps indicating when the first meter obtained the first light information,
wherein the second light information includes one or more second timestamps indicating when the second meter obtained the second light information, and
wherein the correlating of the first light information with the second light information is based on the one or more first timestamps and the one or more second timestamps.

3. The method of claim 1, wherein the first meter is at a media-presentation device, and wherein the second meter is at a panelist, and
wherein the correlating of the first light information with the second light information serves as a basis to detect presence of the panelist at the media-presentation device.

4. The method of claim 3, wherein the correlating of the first light information with the second light information also serves as a basis to detect that, when the media-presentation device was presenting media content, the panelist was present at the media-presentation device.

5. The method of claim 4, further comprising:
receiving, by the computing system, audio information obtained by the first meter, wherein the first meter obtains the audio information while the first meter obtains the first light information;
identifying, based on the audio information, the media content presented by the media-presentation device; and
establishing audience-measurement data, wherein the establishing is based on correlating the identified media content with the panelist.

6. The method of claim 5, wherein the audio information comprises audio signature data.

7. The method of claim 5, wherein the first light information includes one or more first timestamps indicating when the first meter obtained the first light information,
wherein the audio information includes one or more audio timestamps indicating when the first meter obtained the audio information, and
wherein correlating the identified media content with the panelist is based on the one or more first timestamps and one or more audio timestamps.

8. The method of claim 1, wherein correlating, by the computing system, the first light information with the second light information comprises determining a similarity value between the first light information and the second light information, and
wherein detecting presence of the first meter at the same location as the second meter is based on determining that the similarity value is greater than a threshold.

9. The method of claim 8, wherein the similarity value between the first light information and the second light information comprises a Spearman correlation between the first light information and the second light information.

10. The method of claim 1,
wherein the first light information is based on an ambient light intensity at the first meter, and
wherein the second light information is based on an ambient light intensity at the second meter.

11. A system comprising:
a first meter configured to obtain first light information;
a second meter configured to obtain second light information; and
program instructions stored in non-transitory data storage and executable by at least one processor to carry out operations comprising correlating the first light information with the second light information as a basis to detect presence of the first meter at a same location as the second meter.

12. The system of claim 11,
wherein the first light information includes one or more first timestamps indicating when the first meter obtained the first light information,
wherein the second light information includes one or more second timestamps indicating when the second meter obtained the second light information, and
wherein the correlating of the first light information with the second light information is based on the one or more first timestamps and the one or more second timestamps.

13. The system of claim 11,
wherein the first meter is a meter at a media-presentation device, wherein the second meter is a meter at a panelist, and
wherein the correlating of the first light information with the second light information serves as a basis to detect a presence of the panelist at the media-presentation device.

14. The system of claim 13, wherein the correlating of the first light information with the second light information also serves as a basis to detect that, when the media-presentation device was presenting media content, the panelist was present at the media-presentation device.

15. The system of claim 14, wherein the operations further comprise:
receiving audio information obtained by the first meter, wherein the first meter obtains the audio information while the first meter obtains the first light information;
identifying, based on the audio information, the media content presented by the media-presentation device; and
establishing audience-measurement data, wherein the establishing is based on correlating the identified media content with the panelist.

16. The system of claim 15, wherein the audio information comprises audio signature data.

17. The system of claim 11,
wherein correlating the first light information with the second light information comprises determining a similarity value between the first light information and the second light information, and
wherein detecting presence of the first meter at the same location as the second meter is based on determining whether the similarity value is greater than a threshold.

18. The system of claim 17, wherein the similarity value between the first light information and the second light information comprises a Spearman correlation between the first light information and the second light information.

19. The system of claim 11,
wherein the first light information is based on an ambient light intensity at the first meter, and
wherein the second light information is based on an ambient light intensity at the second meter.

20. At least one non-transitory computer-readable medium having stored thereon program instructions executable by at least one processor to carry out operations including:
receiving first light information obtained by a first meter;
receiving second light information obtained by a second meter; and
correlating the first light information with the second light information as a basis to detect presence of the first meter at a same location as the second meter.
